(19) United States
(12) Patent Application Publication
(10) Pub. No.: US 2026/0189870 A1
(43) Pub. Date: Jul. 2, 2026

(54) DATA PROCESSING METHOD AND A CONTROL DEVICE

(71) Applicant: Harman International Industries, Incorporated, Stamford, CT (US)

(72) Inventors: Hongyi ZHU, Shenzhen City (CN); Zheng QIN, Shenzhen City (CN); Hongfei ZHOU, Shenzhen City (CN)

(73) Assignee: Harman International Industries, Incorporated, Stamford, CT (US)

(21) Appl. No.: 19/431,458

(22) Filed: Dec. 23, 2025

(30) Foreign Application Priority Data
Dec. 30, 2024 (CN) 2024119765297

(51) Int. Cl. H04S 7/00

(52) U.S. Cl. CPC H04S 7/303

(57) ABSTRACT

A data processing method and a control device are provided. The method of the present disclosure is directed to a loudspeaker system including a plurality of loudspeakers. By collecting locally measured distance information from respective loudspeakers and determining a real-time spatial layout of the loudspeaker system based on the distance information, automatic layout calibration of the loudspeaker system is achieved. Subsequently, according to the layout of the loudspeaker system, and in combination with an actual orientation of a user and spatial position-related data indicative of a position of a sound source in audio content to be played, corresponding data in the audio content is assigned to corresponding loudspeakers, thereby utilizing playback by the respective loudspeakers to collectively achieve spatial audio rendering, providing an immersive sound experience for the user. The method of the present disclosure does not require additional layout calibration processing, and thus can achieve real-time layout determination without user awareness and can automatically adjust audio playback of the loudspeakers according to changes in the real-time orientation of the user, thereby achieving user orientation-adaptive spatial audio rendering.

### CROSS-REFERENCE TO RELATED APPLICATIONS

This application claims priority to CN application No. 2024119765297 filed Dec. 30, 2024, the disclosure of which is hereby incorporated in its entirety by reference herein.

### TECHNICAL FIELD

The present disclosure relates to the field of audio processing, and more particularly, to a data processing method and a control device.

### BACKGROUND

In today's digital age, the audio experience has become an indispensable part of user entertainment and daily life. To provide end users with a better immersive listening experience, the design and technology of audio products continue to evolve. In this context, spatial audio rendering has gradually become a major trend in the audio industry and is favored by more and more users. This technology aims to create an immersive auditory experience through precise sound rendering, enabling users to perceive the three-dimensionality and directionality of sound. With the development of technology, more and more audio devices begin to support immersive audio content playback, and such content typically has position-related metadata embedded therein, which can help devices identify the position of the sound source, enabling sound to propagate in a more natural and realistic manner, thereby enhancing the user's sense of immersion. However, the sound experience depends not only on the quality of the media content itself but also highly on the configuration of the playback system used by the user, especially the layout of the loudspeakers.

When using devices with spatial audio rendering capabilities, the placement of loudspeakers is quite important. If the positions of the loudspeakers are inaccurate or the layout is unreasonable, even the highest-quality audio content will find it difficult to demonstrate its due immersive effects. This is because the realization of spatial sound effects needs to rely on the directionality and three-dimensionality of sound, both of which are directly affected by the loudspeaker layout. If the placement of the loudspeakers does not match the position of the audio source, the user will have difficulty in experiencing the spatial sound effects.

Therefore, an effective data processing method is needed, which can enable determination of accurate layout of the loudspeakers, thereby achieving spatial audio rendering based on the accurate layout of the loudspeakers.

### SUMMARY

Embodiments of the present disclosure provide a data processing method, a control device, and a corresponding computer program product and a corresponding computer-readable storage medium.

An embodiment of the present disclosure provides a data processing method for audio playback of a loudspeaker system including a plurality of loudspeakers, the method including: acquiring audio data for playback in the loudspeaker system, where the audio data includes spatial position-related data indicative of a position of a sound source in the audio data; receiving loudspeaker distance information from at least a portion of loudspeakers of the plurality of loudspeakers, where for each loudspeaker of the at least a portion of loudspeakers, the loudspeaker distance information indicates distances between the loudspeaker and the other loudspeakers in the at least a portion of loudspeakers; determining a spatial position of each loudspeaker of the at least a portion of loudspeakers based on the received loudspeaker distance information; and processing the audio data based on a detection of orientation of a user, the spatial position of each loudspeaker of the at least a portion of loudspeakers, and the spatial position-related data in the audio data to determine audio content to be played by each loudspeaker of the at least a portion of loudspeakers for providing spatial audio rendering of the audio data for the user.

An embodiment of the present disclosure provides a control device, including: one or more processors; and one or more memories, where the one or more memories have a computer-executable program stored therein, the computer-executable program, when executed by the processors, causing the data processing method as described above to be executed.

An embodiment of the present disclosure provides a computer-readable storage medium having stored thereon computer-executable instructions that, when executed by a processor, cause the above data processing method to be implemented.

An embodiment of the present disclosure provides a computer program product or computer program including computer instructions stored in a computer-readable storage medium. A processor of a computer device reads the computer instructions from the computer-readable storage medium, and the processor executes the computer instructions to cause the computer device to execute the data processing method according to the embodiments of the present disclosure.

The method provided in embodiments of the present disclosure is directed to a loudspeaker system including a plurality of loudspeakers. By collecting locally measured distance information from respective loudspeakers and determining a real-time spatial layout of the loudspeaker system based on the distance information, automatic layout calibration of the loudspeaker system is achieved. Subsequently, according to the layout of the loudspeaker system, and in combination with an actual orientation of a user and spatial position-related data indicative of a position of a sound source in audio content to be played, corresponding data in the audio content is assigned to corresponding loudspeakers, thereby utilizing playback by the respective loudspeakers to collectively achieve spatial audio rendering, providing an immersive sound experience for the user. The method of embodiments of the present disclosure does not require additional layout calibration processing, can achieve real-time layout determination without user awareness, and can automatically adjust audio playback of each loudspeaker according to changes in real-time orientation of the user, thereby achieving user orientation-adaptive spatial audio rendering.

### BRIEF DESCRIPTION OF THE DRAWINGS

In order to more clearly illustrate the technical solutions of the embodiments of the present disclosure, the drawings required for describing the embodiments are briefly introduced below. Apparently, the accompanying drawings described below are merely some exemplary embodiments of the present disclosure, and other accompanying drawings can further be obtained according to these accompanying drawings by those of ordinary skill in the art without creative labor.

FIG. 1 is a schematic diagram illustrating a scenario of performing audio playback using a loudspeaker system according to an embodiment of the present disclosure;

FIG. 2 is a flowchart showing a data processing method according to an embodiment of the present disclosure;

FIG. 3 is a schematic diagram illustrating receiving of distance information from loudspeakers according to an embodiment of the present disclosure;

FIG. 4 is a schematic diagram illustrating user orientation-adaptive spatial audio rendering according to an embodiment of the present disclosure;

FIG. 5 illustrates a schematic diagram of a control device according to an embodiment of the present disclosure; and

FIG. 6 illustrates a schematic diagram of an architecture of an exemplary computing device according to an embodiment of the present disclosure.

### DETAILED DESCRIPTION

In order to make the objectives, technical solutions, and advantages of the present disclosure more obvious, example embodiments according to the present disclosure will be described in detail below with reference to the drawings. Apparently, the described embodiments are merely some of the embodiments of the present disclosure, rather than all the embodiments of the present disclosure. It should be understood that the present disclosure is not limited by the example embodiments described herein.

In this specification and the drawings, substantially the same or similar steps and elements are denoted by the same or similar reference numerals, and duplicated description of these steps and elements will be omitted. Meanwhile, in the description of the present disclosure, terms “first”, “second”, and the like are used only for distinguishing description and cannot be understood as indicating or implying relative importance or ordering.

In the embodiments of the present disclosure, the term “module” or “unit” refers to a computer program or a segment of a computer program that has a predetermined function and works together with other related parts to achieve a predetermined goal, and can be implemented entirely or in part by using software, hardware (such as a processing circuit or memory), or a combination thereof. Likewise, one processor (or a plurality of processors or memories) can be used for implementing one or more modules or units. Further, each module or unit may be a part of an integral module or unit that includes the function of the module or unit.

Unless otherwise defined, all technical and scientific terms used herein have the same meanings as commonly understood by those skilled in the technical field to which the present disclosure belongs. The terms used herein are for the purpose of describing embodiments of the present invention only and are not intended to limit the present invention.

To facilitate the description of the present disclosure, concepts related to the present disclosure are introduced below.

The data processing method of the present disclosure may be based on spatial audio rendering. Spatial audio rendering is a technology that simulates the propagation of sound in three-dimensional space, aiming to create an immersive auditory experience. Different from traditional stereo or mono audio transmission, spatial audio provides a more complex and realistic audio environment, enabling users to perceive sound coming from different directions and distances, thereby enhancing their interactive experience. For example, spatial audio can simulate the effect of sound originating from different positions (such as front, rear, left, right, up, down, or the like). This sense of direction helps users judge the spatial position of the sound source. In addition to direction, spatial audio can also represent a sense of distance of sound. Users can feel whether the sound is near or far, which is typically achieved by means of volume, frequency characteristics, and delay. Spatial audio technology can also simulate the reflection and reverberation of sound in different environments, such as different acoustic field characteristics of open spaces, rooms, corridors, etc.

The data processing method of the present disclosure may also be based on Bluetooth channel sounding. Bluetooth channel sounding is a technology used to detect and analyze the propagation characteristics of Bluetooth signals, which is mainly used to evaluate the quality of communication between Bluetooth devices, distance measurement, and environmental impact, etc. For example, the distance between devices can be estimated by measuring the received signal strength indicator (RSSI), where there is no simple linear relationship between RSSI values and distances, and it can be affected by various factors (such as obstacles, reflections, or the like). In the present disclosure, the Bluetooth channel sounding method can be utilized to achieve high-precision distance measurement between loudspeakers, enabling multiple loudspeakers to work together to generate a highly immersive surround sound effect, and optimizing the sound field according to the position of the user.

In summary, the solutions provided in the embodiments of the present disclosure involve technologies such as spatial audio rendering and Bluetooth channel sounding. The embodiments of the present disclosure will be further described below in conjunction with the accompanying drawings.

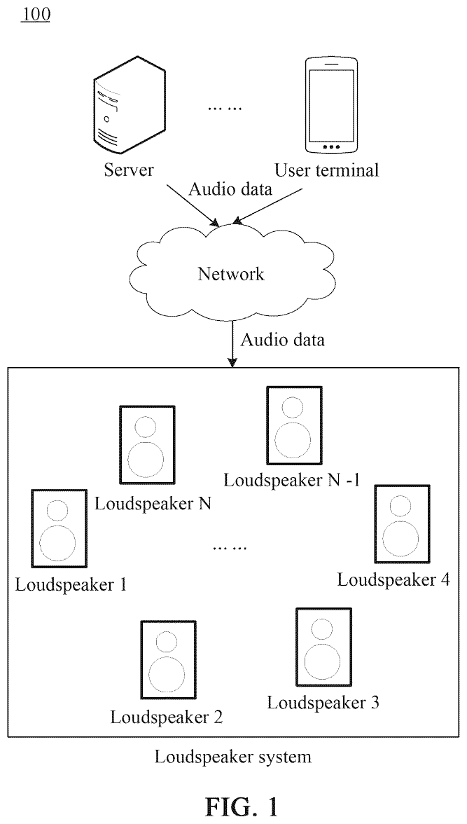

FIG. 1 is a schematic diagram illustrating a scenario of performing audio playback using a loudspeaker system according to an embodiment of the present disclosure.

As shown in FIG. 1, the loudspeaker system may acquire audio data to be played from various data sources including a server, a user terminal, or the like. These audio data may be transmitted to the loudspeaker system through a network, or may be directly provided to the loudspeaker system by means of wired communication, for the loudspeaker system to reproduce the audio data.

For example, the server, as a storage center for audio data, may be responsible for managing and sending the audio data to the network. Here, the server may be an independent physical server, may also be a server cluster or a distributed system composed of multiple physical servers, and may also be a cloud server that provides foundational cloud computing services such as cloud services, cloud databases, cloud computing, cloud functions, cloud storage, network services, cloud communication, middleware services, domain name services, security services, CDN, as well as big data and artificial intelligence platforms.

As another example, the audio data may also be provided to the loudspeaker system by a user terminal, where a user may transmit audio data to the loudspeaker system through the user terminal, or may connect to the server to select and control audio content to be played, and instruct the server to transmit the audio content to the loudspeaker system. Optionally, the user terminal may specifically include a smartphone, a tablet computer, a laptop portable computer, a desktop computer, an in-vehicle terminal, a wearable device, and the like. Optionally, the network may be an Internet of Things (IoT) based on the Internet and/or a telecommunications network, which may be a wired network or a wireless network; for example, it may be a local area network (LAN), a metropolitan area network (MAN), a wide area network (WAN), a cellular data communication network, or other electronic networks capable of realizing information exchange functions.

Here, the loudspeaker system may be composed of a plurality of loudspeakers (e.g., loudspeakers 1, 2, 3, 4, . . . , N). Each loudspeaker may play audio independently, and according to requirements, may work cooperatively to create a surround sound or spatial sound effect, thereby enhancing the immersive experience for the user.

In order to provide an immersive listening experience for the user by using the loudspeaker system, in addition to focusing on the quality of the audio content itself, it is also necessary to calibrate the layout positions of the loudspeakers in the loudspeaker system. This is because the spatial layout of the loudspeakers is crucial for an immersive sound experience. For example, if the positions of the loudspeakers do not match the audio content, it may lead to disorder of the perceived direction of the sound source, resulting in incorrect spatial perception. As an example, in a home theater, a reasonable configuration of front loudspeakers, surround loudspeakers, and subwoofers can create a three-dimensional sound field, enabling listeners to correctly perceive sound coming from different directions, thereby enhancing the sense of immersion of watching a movie. Conversely, if the loudspeaker positions are improper, causing audio to be assigned to incorrect loudspeakers, for example, front dialogue being assigned to rear surrounds, the audience will perceive incorrect sound source localization, leading to confusion in spatial perception and affecting the overall viewing experience.

Therefore, in order to achieve the optimal sound performance of the audio data by utilizing the layout of the loudspeakers, the process of calibrating the layout of the loudspeaker system is very important. Currently, a commonly used loudspeaker layout calibration method involves detecting the positions of the loudspeakers through calibration processing, which may include the following steps:
\textcircled{1} Playing a calibration signal: A loudspeaker may play a specific calibration signal (such as pink noise or an impulse signal); these signals can cover a certain frequency range, helping to detect the performance of the loudspeaker.
\textcircled{2} Recording the calibration signal: By placing microphones in the room, the calibration signal played by the loudspeaker is recorded. These microphones can capture the propagation characteristics of the sound in space, including information such as delay, reflection, and frequency response.
\textcircled{3} Data processing and analysis: The recorded signal data is analyzed to estimate the actual positions of the loudspeakers.

Although the positions of the respective loudspeakers can be determined through the aforementioned calibration method, this introduces additional calibration processing and corresponding processing time to perform the above operations, which is undesirable for many end users because users often wish to quickly enjoy high-quality audio experiences, while a lengthy calibration process may reduce their user experience.

Based on this, the present disclosure provides a data processing method, which is directed to a loudspeaker system including a plurality of loudspeakers. By collecting locally measured distance information from respective loudspeakers and determining a real-time spatial layout of the loudspeaker system based on the distance information, automatic layout calibration of the loudspeaker system is achieved. Subsequently, according to the layout of the loudspeaker system, and in combination with an actual orientation of a user and spatial position-related data indicative of a position of a sound source in audio content to be played, corresponding data in the audio content is assigned to corresponding loudspeakers, thereby utilizing playback by the respective loudspeakers to collectively achieve spatial audio rendering, providing an immersive sound experience for the user. The method of the present disclosure does not require additional layout calibration processing, and thus can achieve real-time layout determination without user awareness and can automatically adjust audio playback of the loudspeakers according to changes in the real-time orientation of the user, thereby achieving user orientation-adaptive spatial audio rendering.

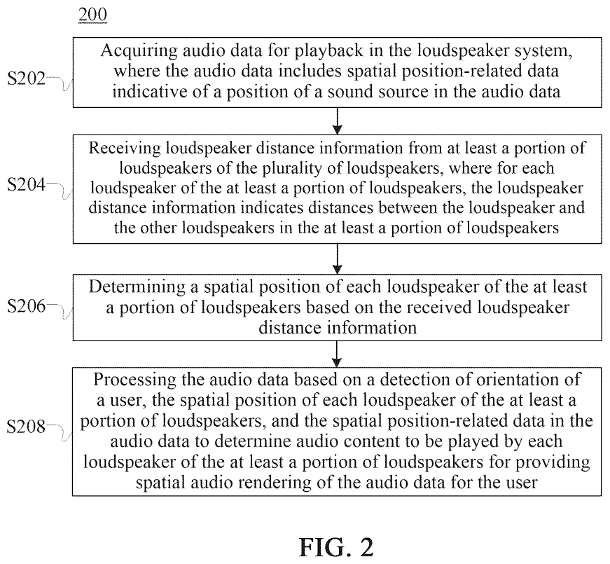

FIG. 2 is a flowchart illustrating a data processing method 200 according to an embodiment of the present disclosure. Optionally, the data processing method of the present disclosure may be applicable to the loudspeaker system including a plurality of loudspeakers as described above, where these loudspeakers may be connected together through a local area network (e.g., mobile hotspot Wi-Fi, etc.) to effectively share audio signals and perform real-time synchronization, where each loudspeaker may have the capability to run audio playback and rendering and may be randomly placed in three-dimensional space.

Considering the random placement of the loudspeakers, the data processing method of the present disclosure needs to take into account both spatial positioning and sound effect correction. Specifically, the data processing method of the present disclosure may analyze the relative positions between the loudspeakers and, as an end-user-level data processing method, is capable of performing spatialization processing on the audio signal with respect to the user to ensure the user's perception of spatiality and presence in the auditory experience.

Optionally, the data processing method of the present disclosure may be performed by a control device. This control device may be one loudspeaker in the loudspeaker system of the present disclosure, or may be another device having the capability to run audio playback and rendering, which is not limited in the present disclosure.

In step S202, audio data for playback in the loudspeaker system may be acquired, where the audio data may include spatial position-related data indicative of a position of a sound source in the audio data.

Optionally, the audio data may be audio content provided to the loudspeaker system of the present disclosure by other devices, or may be built-in audio content of the loudspeaker system of the present disclosure, which is not limited in the present disclosure.

Optionally, the audio data to be played by the loudspeaker system may include position-related metadata. The position-related metadata may describe the position of the sound source in the audio content. For example, it may describe, including but not limited to, a position (e.g., three-dimensional coordinates) of one or more sound sources in three-dimensional space, a nature of the sound source (e.g., audio channel, sound source distance, directivity, volume, or the like), a time at which the sound source appears and possible changes (e.g., a moving sound source), and/or environmental information such as reflection characteristics, an acoustic model, etc.

Optionally, based on the position-related metadata in the audio data (i.e., the spatial position-related data in the present disclosure), a state such as a position and a distance that each sound source in the audio data should have in the three-dimensional space may be determined, and based on this, respective outputting may be performed by utilizing the respective loudspeakers in the loudspeaker system, thereby providing an immersive listening experience for the user.

Therefore, in order to utilize the respective loudspeakers in the loudspeaker system to perform correct audio output to present a spatial audio rendering effect, next, calibration of the spatial layout of loudspeakers in the loudspeaker system is required.

In step S204, loudspeaker distance information may be received from at least a portion of the plurality of loudspeakers, where for each loudspeaker of the at least a portion of loudspeakers, the loudspeaker distance information may indicate distances between the loudspeaker and the other loudspeakers in the at least a portion of loudspeakers.

Optionally, to calibrate the spatial layout of loudspeakers in the loudspeaker system, in an embodiment of the present disclosure, distances between the respective loudspeakers participating in spatial audio rendering in the loudspeaker system may be collected to determine the spatial position of each loudspeaker based on an analysis of the distances.

Optionally, each loudspeaker in the loudspeaker system of the present disclosure may be equipped with a Bluetooth channel sounding function. Specifically, the respective loudspeakers may perform distance measurement between the loudspeakers through Bluetooth channel sounding. For example, they may utilize characteristics (e.g., signal strength, etc.) of a Bluetooth signal to estimate a distance between devices.

According to an embodiment of the present disclosure, the loudspeaker distance information may be obtained by the loudspeakers through Bluetooth channel sounding.

Optionally, a loudspeaker in the loudspeaker system may use a Bluetooth application programming interface (API) to acquire a received signal strength indicator (RSSI) value of a loudspeaker paired with it and calculate a distance between itself and that loudspeaker based on the RSSI value. Certainly, each loudspeaker in the loudspeaker system of the present disclosure may also determine distances between itself and other loudspeakers or other devices through Bluetooth channel sounding in other ways, which is not limited in the present disclosure.

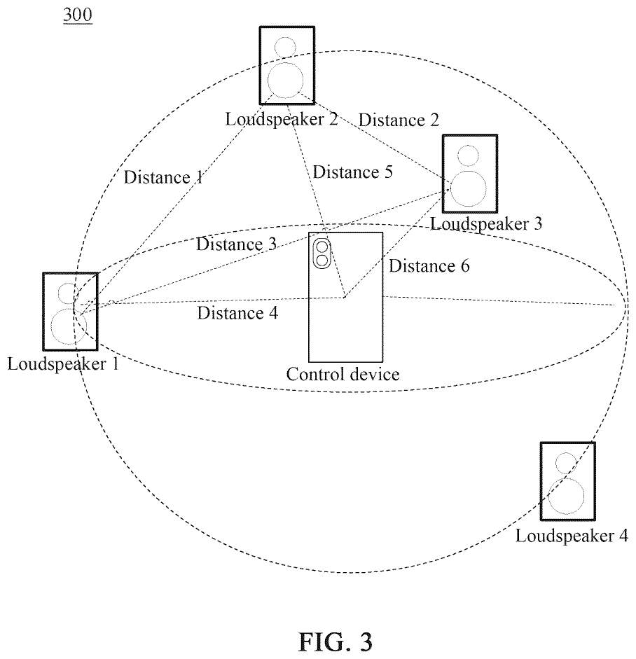

FIG. 3 is a schematic diagram illustrating receiving of distance information from loudspeakers according to an embodiment of the present disclosure.

As shown in FIG. 3, as a device executing the data processing method of the present disclosure, a control device may receive, from at least a portion of loudspeakers in the loudspeaker system (e.g., loudspeakers participating in spatial audio rendering), such as loudspeakers 1, 2, and 3 in FIG. 3, distance information collected by these loudspeakers, for example, distance 1 between loudspeaker 1 and loudspeaker 2, distance 2 between loudspeaker 2 and loudspeaker 3, and distance 3 between loudspeaker 1 and loudspeaker 3 in FIG. 3. Furthermore, optionally, the control device itself may also obtain distances between itself and these loudspeakers through Bluetooth channel sounding, for example, distance 4 to loudspeaker 1, distance 5 to loudspeaker 2, and distance 6 to loudspeaker 3 in FIG. 3.

Optionally, for other loudspeakers in the loudspeaker system, for example, loudspeaker 4 in FIG. 3, it may be determined not to participate in the current spatial audio rendering. For example, it may actively send indication information to the control device to indicate non-participation in spatial audio rendering, or the control device may determine that the loudspeaker does not participate in spatial audio rendering through detection of the loudspeaker (for example, in a case where the loudspeaker is faulty or is used to perform other tasks, etc.). Based on this, the data processing method of the present disclosure is robust to unexpected situations such as loudspeaker failure in the loudspeaker system, and it may achieve spatial audio rendering by using other loudspeakers.

In step S206, a spatial position of each loudspeaker of the at least a portion of loudspeakers may be determined based on the received loudspeaker distance information.

According to an embodiment of the present disclosure, determining the spatial position of each loudspeaker of the at least a portion of loudspeakers based on the received loudspeaker distance information may include: constructing a loudspeaker distance matrix based on the received loudspeaker distance information; and determining spatial coordinates of each loudspeaker of the at least a portion of loudspeakers according to the loudspeaker distance matrix based on a number of loudspeakers in the at least a portion of loudspeakers.

Optionally, a loudspeaker distance matrix may be constructed based on the collected loudspeaker distance information. Specifically, the matrix may contain distance information between loudspeakers participating in spatial audio rendering in the loudspeaker system and distance information between these loudspeakers and the control device, so as to provide foundational data for subsequent spatial position determination. Through this matrix, relative positional relationships between the loudspeakers may be captured, thereby laying a foundation for spatial layout analysis of the loudspeaker system.

As an example, assume that there are currently N loudspeakers in the loudspeaker system participating in spatial audio rendering, and there is one control device for performing spatial audio rendering using the N loudspeakers. Based on this, three-dimensional coordinates of this control device may be represented as \vec{a}₁=(x₁,y₁,z₁)^{T}, coordinates of the i-th device (which may be a loudspeaker or the control device) among the N loudspeakers and the control device may be \vec{a}ᵢ=(xᵢ,yᵢ,zᵢ)^{T}(2≤i≤N+1), and the three-dimensional coordinates of these devices may form a coordinate matrix A as follows:

$$A = {( {\vec{a}}_{1} , {\vec{a}}_{2} , … , {\vec{a}}_{N} )}^{T} = ( \begin{matrix}{x}_{1} & {y}_{1} & {z}_{1} \\ {x}_{2} & {y}_{2} & {z}_{2} \\ ⋮ & ⋮ & ⋮ \\ {x}_{N + 1} & {y}_{N + 1} & {z}_{N + 1}\end{matrix} ) \qquad ( 1 )$$

Therefore, based on Bluetooth channel sounding technology, each loudspeaker may detect distances between itself and other loudspeakers and the control device. Similarly, the control device may also detect distances between itself and other loudspeakers. Based on this, a loudspeaker distance matrix D may be generated as follows:

$$D = ( \begin{matrix}{d}_{1.1} & {d}_{1.2} & … & {d}_{1 , N} \\ {d}_{2.1} & {d}_{2.2} & … & {d}_{2 , N} \\ ⋮ & ⋮ & ⋱ & ⋮ \\ {d}_{N , 1} & {d}_{N , 2} & … & {d}_{N , N}\end{matrix} ) \qquad ( 2 )$$

where d_{i,j} denotes the distance between the i-th device and the j-th device, which is estimated by the j-th device.

Based on the above Equation (2), it can be seen that:

$${d}_{i , j}^{2} = {d}_{j , i}^{2} = {( {\vec{a}}_{i} - {\vec{a}}_{j} )}^{T} ( {\vec{a}}_{i} - {\vec{a}}_{j} ) = {( {x}_{i} - {x}_{j} )}^{2} + {( {y}_{i} - {y}_{j} )}^{2} + {( {z}_{i} - {z}_{j} )}^{2} = {x}_{i}^{2} + {y}_{i}^{2} + {z}_{i}^{2} + {x}_{j}^{2} + {y}_{j}^{2} + {z}_{j}^{2} - 2 {x}_{i} {x}_{j} - 2 {y}_{i} {y}_{j} - 2 {z}_{i} {z}_{j} \qquad ( 3 )$$

That is to say, due to the symmetry and positive value nature of the matrix, the loudspeaker distance matrix is positive semi-definite; therefore, eigenvalue decomposition may be applied to calculate the spatial coordinates of each loudspeaker based on this loudspeaker distance matrix.

Considering the complexity of matrix calculation, in an embodiment of the present disclosure, a method for determining the spatial positions of the loudspeakers may be selected based on the scale size (for example, based on the number of these loudspeakers) of the loudspeakers participating in spatial audio rendering in the loudspeaker system.

According to an embodiment of the present disclosure, determining the spatial coordinates of each loudspeaker of the at least a portion of loudspeakers according to the loudspeaker distance matrix based on the number of loudspeakers in the at least a portion of loudspeakers may further include: in a case where the number of loudspeakers in the at least a portion of loudspeakers satisfies a predetermined condition, determining the spatial coordinates of each loudspeaker of the at least a portion of loudspeakers through multidimensional scaling according to the loudspeaker distance matrix.

In an embodiment of the present disclosure, the predetermined condition may be that the number of loudspeakers in the at least a portion of loudspeakers is less than a predetermined number threshold. Optionally, when the number of loudspeakers participating in spatial audio rendering is less than the preset number threshold, it may be considered that the scale of loudspeakers participating in spatial audio rendering is small; therefore, a multidimensional scaling (MDS) method may be employed to extract effective spatial position information from the loudspeaker distance matrix.

According to an embodiment of the present disclosure, determining the spatial coordinates of each loudspeaker of the at least a portion of loudspeakers through multidimensional scaling according to the loudspeaker distance matrix may include: transforming the loudspeaker distance matrix to cause the loudspeaker distance matrix to have a zero mean; performing eigenvalue decomposition on the loudspeaker distance matrix having the zero mean to determine one or more eigenvalues of the loudspeaker distance matrix having the zero mean and one or more eigenvectors corresponding to the one or more eigenvalues; and determining the spatial coordinates of each loudspeaker of the at least a portion of loudspeakers based on the one or more eigenvalues and the one or more eigenvectors.

Optionally, in the process of employing the MDS method to extract effective spatial position information from the loudspeaker distance matrix, the loudspeaker distance matrix may first be transformed, for example, by applying a centering matrix, so as to cause it to have a zero mean for further analysis.

As an example, the centering matrix C may be applied to the aforementioned loudspeaker distance matrix D, for example:

$$B = \frac{1}{2} CDC \qquad ( 4 )$$

where the centering matrix C may be represented as:

$$C = I - \frac{1}{N} E \qquad ( 5 )$$

where I is an identity matrix of dimension N×N, and E is an all-ones matrix of dimension N×N.

Based on this, an eigenvalue vector \vec{λ} of the matrix B and a corresponding eigenvector matrix V may be determined by performing eigenvalue decomposition on the loudspeaker distance matrix B having the zero mean. Here, the eigenvalue vector \vec{λ} may include one or more eigenvalues of the matrix B, and the eigenvector matrix V may include one or more eigenvectors having a one-to-one correspondence with the one or more eigenvalues.

By performing eigenvalue decomposition on the loudspeaker distance matrix, key features of the spatial layout of the loudspeaker system can be effectively extracted, and due to the zero-mean property of the loudspeaker distance matrix, its eigenvalue vector and eigenvector matrix can reflect the inherent structure of the loudspeaker layout.

In the eigenvalue decomposition, based on the layout dimension of the loudspeakers, the largest m eigenvalues may be selected from the N eigenvalues of the matrix B, and m eigenvectors corresponding to the m eigenvalues may be determined, where the value of m (m≤3) depends on the dimension of the loudspeaker layout.

For example, if the loudspeakers are arranged in a straight line, due to the constraints of one-dimensional space, the main characteristics of the loudspeaker system are concentrated in this single direction, resulting in an eigenvalue distribution where only one largest eigenvalue λ₁ exists and the other eigenvalues are zero.

For example, if the loudspeakers are arranged in a two-dimensional plane, the loudspeaker system will exhibit two largest eigenvalues λ₁ and λ₂, and the other eigenvalues will still be zero, which reflects the effective capture of information in the two dimensions.

As another example, if the loudspeakers are arranged in a three-dimensional space, the layout of the loudspeakers will introduce three largest eigenvalues λ₁, λ₂, and λ₃, with the other eigenvalues being zero.

By combining the extracted eigenvalues and eigenvectors, the position of each loudspeaker in the three-dimensional space can be accurately located. For example, the coordinate matrix of the loudspeakers participating in spatial audio rendering may be calculated as

$$A = {V}_{m} {Λ}_{m}^{1 / 2} ,$$

where Λₘ denotes a diagonal matrix formed by the selected m eigenvalues, i.e., an m×m square matrix where the m elements on the diagonal are the m eigenvalues while the off-diagonal elements are all zero, and Vₘ denotes the eigenvector matrix composed of the corresponding m eigenvectors.

Based on this, when the scale of loudspeakers participating in spatial audio rendering is small, the spatial coordinates of each loudspeaker may be determined by using multidimensional scaling of the loudspeaker distance matrix. However, when the loudspeaker scale reaches a certain level, for example, when their number exceeds a predetermined threshold (which may be determined based on the computational capability of the control device in practical applications, and is not limited by the present disclosure), due to the computational complexity and accuracy limitations caused by the excessively large matrix dimension, in an embodiment of the present disclosure, another method is proposed to determine the loudspeaker spatial layout in this case, so as to improve the efficiency and accuracy of spatial layout determination under large-scale loudspeaker configurations.

According to an embodiment of the present disclosure, determining the spatial coordinates of each loudspeaker of the at least a portion of loudspeakers according to the loudspeaker distance matrix based on the number of loudspeakers in the at least a portion of loudspeakers may further include: in a case where the number of loudspeakers in the at least a portion of loudspeakers does not satisfy a predetermined condition, determining the spatial coordinates of each loudspeaker of the at least a portion of loudspeakers according to the loudspeaker distance matrix by minimizing an objective function, where the objective function indicates differences between distances between loudspeakers determined based on estimated spatial coordinates of each loudspeaker of the at least a portion of loudspeakers and corresponding distances in the loudspeaker distance matrix.

Optionally, the aforementioned problem of solving the loudspeaker spatial layout may be transformed into solving the following convex optimization problem:

$$A = arg min {\sum }_{i = 1}^{N} {\sum }_{j = 1}^{N} {[ \vert {\vec{a}}_{i} - {\vec{a}}_{j} \vert - {d}_{i , j} ]}^{2} \qquad ( 6 )$$

where \vec{a}ᵢ-\vec{a}ⱼ denotes the distance between the i-th device and the j-th device described above, and d_{i,j} denotes the distance between the i-th device and the j-th device measured as described above. Therefore, by minimizing this objective function, the control device can gradually adjust the spatial coordinates of each loudspeaker, making the estimated inter-loudspeaker distances match the actual distance matrix data, thereby effectively reducing errors caused by high dimensionality and improving the stability and accuracy of the entire computational model.

According to an embodiment of the present disclosure, determining the spatial coordinates of each loudspeaker of the at least a portion of loudspeakers according to the loudspeaker distance matrix based on the number of loudspeakers in the at least a portion of loudspeakers may further include: transforming the objective function into a bilinear matrix form and determining the spatial coordinates of each loudspeaker of the at least a portion of loudspeakers through eigenvalue decomposition.

Optionally, the aforementioned convex optimization problem may be transformed into a bilinear form.

Specifically, the coordinates of the control device may be set as \vec{a}1=(x₁,y₁,z₁)=(0,0,0) as a reference; therefore, the following can be obtained:

$$\{ \begin{matrix}{d}_{i , j}^{2} - {d}_{1 , j}^{2} = {x}_{i}^{2} + {y}_{i}^{2} + {z}_{i}^{2} - {x}_{1}^{2} - {y}_{1}^{2} - {z}_{1}^{2} - 2 ( {x}_{i} - {x}_{1} ) {x}_{j} - 2 ( {y}_{i} - {y}_{1} ) {y}_{j} - \\ 2 ( {z}_{i} - {z}_{1} ) {z}_{j} \\ {d}_{1.1}^{2} - {d}_{i , 1}^{2} = {x}_{1}^{2} + {y}_{1}^{2} + {z}_{1}^{2} - {x}_{i}^{2} - {y}_{i}^{2} - {z}_{i}^{2} - 2 ( {x}_{1} - {x}_{i} ) {x}_{1} - 2 ( {y}_{1} - {y}_{i} ) {y}_{1} - \\ 2 ( {z}_{1} - {z}_{i} ) {z}_{1}\end{matrix} \qquad ( 7 )$$

Therefore,

$${d}_{i , j}^{2} - {d}_{1 , j}^{2} + {d}_{1.1}^{2} - {d}_{i , 1}^{2} = - 2 [ ( {x}_{i} - {x}_{1} ) ( {x}_{j} - {x}_{1} ) + ( {y}_{i} - {y}_{1} ) ( {y}_{j} - {y}_{1} ) + ( {z}_{i} - {z}_{1} ) ( {z}_{j} - {z}_{1} ) ] = - 2 [ {x}_{i} {x}_{j} + {y}_{i} {y}_{j} + {z}_{i} {z}_{j} ] \qquad ( 8 )$$

Based on this, the aforementioned convex optimization problem can be represented in a matrix form as follows:

$$\tilde{A} {\tilde{A}}^{T} = \tilde{D} \qquad ( 9 )$$

$$\tilde{A} = ( \begin{matrix}{x}_{2} & {y}_{2} & {z}_{2} \\ {x}_{3} & {y}_{3} & {z}_{3} \\ ⋮ & ⋮ & ⋮ \\ {x}_{N + 1} & {y}_{N + 1} & {z}_{N + 1}\end{matrix} ) \qquad ( 10 )$$

$$\tilde{D} = ( \begin{matrix}{\tilde{d}}_{1.1} & {\tilde{d}}_{1.2} & … & {\tilde{d}}_{1 , N - 1} \\ {\tilde{d}}_{2.1} & {\tilde{d}}_{2.2} & … & {\tilde{d}}_{2 , N - 1} \\ ⋮ & ⋮ & ⋱ & ⋮ \\ {\tilde{d}}_{N - 1 , 1} & {\tilde{d}}_{N - 1 , 2} & … & {\tilde{d}}_{N - 1 , N - 1}\end{matrix} ) \qquad ( 11 )$$

where

$${\tilde{d}}_{i - 1 , j - 1} = - \frac{1}{2} ( {d}_{i , j}^{2} - {d}_{1 , j}^{2} + {d}_{1.1}^{2} - {d}_{i , 1}^{2} ) = - \frac{1}{2} ( {d}_{i , j}^{2} - {d}_{1 , j}^{2} - {d}_{i , 1}^{2} ) ,$$

and T denotes a transpose operator.

Therefore, similarly to the use of the MDS method as described above, eigenvalue decomposition can be applied to the new distance matrix D to obtain:

$$\{ \begin{matrix}\tilde{A} {\tilde{A}}^{T} = \tilde{D} = U Λ {U}^{T} \\ \tilde{A} = U {Λ}^{1 / 2}\end{matrix} \qquad ( 12 )$$

where Λ denotes a diagonal matrix of dimension 3×3 constituted by the eigenvalues of the matrix \tilde{D}, and U denotes the corresponding eigenvector matrix of these eigenvalues.

Based on this, Ã, i.e., the coordinate matrix of the N loudspeakers, can be determined.

Furthermore, in an embodiment of the present disclosure, considering that since various reflections and obstacles are often present in real environments, the accuracy of distance measurement based on Bluetooth technology may be affected, when factors affecting signal propagation exist during the measurement process, certain values in the distance matrix may become unreliable, thereby leading to errors in subsequent analyses based on these data. Therefore, it is necessary to optimize the distance matrix to correct these unreliable distance values.

According to an embodiment of the present disclosure, determining the spatial coordinates of each loudspeaker of the at least a portion of loudspeakers according to the loudspeaker distance matrix based on the number of loudspeakers in the at least a portion of loudspeakers may further include: optimizing the loudspeaker distance matrix to correct unreliable distances in the loudspeaker distance matrix; and determining the spatial coordinates of each loudspeaker of the at least a portion of loudspeakers based on the optimized loudspeaker distance matrix.

Optionally, during the optimization process for the loudspeaker distance matrix, unreliable values in the loudspeaker distance matrix calculated as above can be processed. For example, for the aforementioned matrix \tilde{D}, values therein corresponding to the unreliable values can be set to a constant to reduce the impact of uncertainty on the optimization result. For example, an element \tilde{d}_{i,j} in the matrix \tilde{D} may be represented as follows:

$${\tilde{d}}_{i , j} = \{ \begin{matrix}{\tilde{d}}_{i , j} , if {\tilde{d}}_{i , j} is reliable \\ constant , if {\tilde{d}}_{i , j} is unreliable\end{matrix} \qquad ( 13 )$$

Optionally, the reliability of the corresponding element in the distance matrix may be determined based on a judgment of the reliability of the obtained distance information. As an example, the judgment basis for the reliability of the obtained distance information may include additional information of the distance measurement, including but not limited to, for example, the quality of the Bluetooth signal, cross-validation among distance data, and assistance from directional information of the loudspeakers, and the like. For example, if certain distance measurement values significantly deviate from other measurement values, or exhibit inconsistency through cross-validation among the distance data, they can be regarded as unreliable values.

By comprehensively analyzing such information, an initial judgment on the unreliable values in the loudspeaker distance matrix can be determined. Based on this, by setting these unreliable values to a constant, it is possible to effectively prevent them from negatively impacting the overall optimization result, causing the optimization result to approach the reliable values in the distance matrix and have higher accuracy.

As an example, based on the solving process of the aforementioned convex optimization problem, for example, referring to Equation (12), the distance matrix to be optimized can be represented in a bilinear form, i.e., F=U, and P=ΛU^{T}. Therefore, the optimization problem for the loudspeaker distance matrix can be transformed into solving the following problem:

$$arg min {‖ \tilde{D} - FP ‖}^{2} \qquad ( 14 )$$

Optionally, this optimization problem can be solved through the existing iterative algorithms; the present disclosure does not limit the specific solving method. Therefore, through iterative solving, the optimized values of F and P can be determined. Based on this, through Equation (12), the optimized \tilde{D} can be determined, where the unreliable distance values have been optimized.

Therefore, the optimized coordinate matrix of the N loudspeakers can be determined through Equation (12).

By selecting a method for determining the spatial positions of the loudspeakers based on the scale size of the loudspeakers participating in spatial audio rendering in the loudspeaker system, significant efficiency optimization, as well as significant improvement in robustness and accuracy, can be brought to loudspeaker spatial layout calibration. Furthermore, by flexibly selecting an appropriate method according to the scale of the loudspeakers, the data processing method of the present disclosure can be applicable to various listening scenarios, thereby simplifying system design and management, and avoiding unnecessary complexity.

Through the processing described above with reference to steps S202-S206, the spatial coordinates of the loudspeakers participating in spatial audio rendering in the loudspeaker system relative to the control device can be determined. However, due to the lack of user orientation information, these spatial coordinates may have a rotation angle error relative to the actual layout of the loudspeakers relative to the user. Therefore, in order to provide the user with an immersive listening experience, these spatial coordinates need to be corrected relative to the user.

Therefore, in step S208, the audio data may be processed based on a detection of orientation of a user, the spatial position of each loudspeaker of the at least a portion of loudspeakers, and the spatial position-related data in the audio data to determine audio content to be played by each loudspeaker of the at least a portion of loudspeakers for providing spatial audio rendering of the audio data for the user.

According to an embodiment of the present disclosure, processing the audio data based on the detection of the orientation of the user, the spatial position of each loudspeaker of the at least a portion of loudspeakers, and the spatial position-related data in the audio data may include: transforming the spatial position of each loudspeaker of the at least a portion of loudspeakers based on the detection of the orientation of the user to determine a spatial position of each loudspeaker of the at least a portion of loudspeakers relative to the user; and determining the audio content to be played by each loudspeaker of the at least a portion of loudspeakers from the audio data according to the spatial position-related data in the audio data based on the spatial position of each loudspeaker of the at least a portion of loudspeakers relative to the user.

Optionally, in order to correct the spatial layout of the loudspeakers for the user, the current orientation of the user needs to be obtained. For example, the control device may detect the direction of a loudspeaker by detecting the angle of arrival (AOA) of a Bluetooth signal transmitted by the loudspeaker, thereby calculating the orientation of the user. As another example, the control device may be equipped with an integrated camera, which can, with the user's permission, capture user images and detect the direction of user orientation through image recognition. It should be understood that the aforementioned method for obtaining the current orientation of the user is used herein only as an example and not as limitations; the present disclosure may also adopt other methods to obtain user orientation.

Therefore, based on the obtained user orientation, the previously determined spatial layout of the loudspeakers can be transformed. For example, a rotation matrix may be determined based on the relative positional relationship between the control device and the user, and this rotation matrix may be applied to the spatial layout of the loudspeakers to correct the rotation angle error relative to the actual layout of the loudspeakers with respect to the user, thereby determining the actual position of each loudspeaker relative to the user.

Based on the actual position of each loudspeaker relative to the user and the spatial coordinates of the sound source in the audio data, the playback content (for example, which audio signals each loudspeaker should emit) and effects (for example, volume levels, delay, and the like) for each loudspeaker can be determined; these playback contents collectively provide the user with an immersive listening experience.

As an example, the spatial coordinates of a virtual sound source in the audio data may be used to indicate the position of the sound source in three-dimensional space, thereby enabling the assignment of appropriate audio output to each loudspeaker. Specifically, according to the distance between the loudspeaker and the sound source, the volume and the delay time that each loudspeaker needs to output may be calculated. For example, a loudspeaker that is closer should output a higher volume, and the delay time of the audio signal should be shorter, and vice versa. Through precise control of the output of different loudspeakers, in combination with the actual position and the orientation of the user, the user's sense of immersion can be significantly enhanced, creating an experience where the sound realistically surrounds the user from all directions. Furthermore, the output of each loudspeaker may be adjusted in real time according to changes in the position and the movement of the user, such that the user is always in an optimal listening environment.

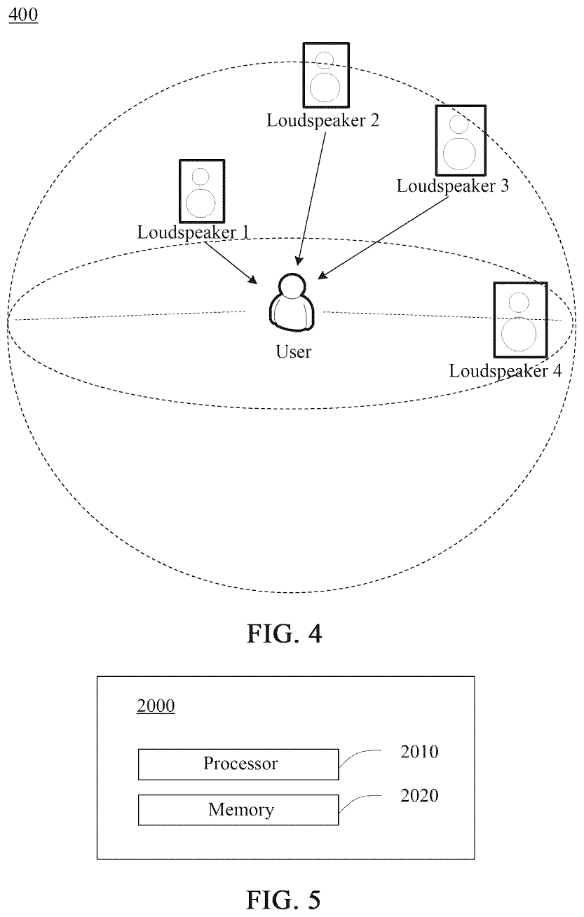

FIG. 4 is a schematic diagram illustrating user orientation-adaptive spatial audio rendering according to an embodiment of the present disclosure.

As shown in FIG. 4, each loudspeaker participating in spatial audio rendering in the loudspeaker system (for example, loudspeakers 1, 2, and 3 as described above with reference to FIG. 3) can play corresponding audio content to the user to provide the user with an immersive listening experience, while a loudspeaker not participating in spatial audio rendering, for example, loudspeaker 4, may not output to the user.

As can be seen from the above description, the data processing method of the present disclosure is directed to a loudspeaker system including a plurality of loudspeakers. By collecting locally measured distance information from respective loudspeakers and determining a real-time spatial layout of the loudspeaker system based on the distance information, automatic layout calibration of the loudspeaker system is achieved. Subsequently, according to the layout of the loudspeaker system, and in combination with an actual orientation of a user and spatial position-related data indicative of a position of a sound source in audio content to be played, corresponding data in the audio content is assigned to corresponding loudspeakers, thereby utilizing playback by the respective loudspeakers to collectively achieve spatial audio rendering, providing an immersive sound experience for the user. The data processing method of the present disclosure does not require additional layout calibration processing, can achieve real-time layout determination without user awareness, and can automatically adjust audio playback of each loudspeaker according to changes in real-time orientation of the user, thereby achieving user orientation-adaptive spatial audio rendering. Furthermore, since the data processing method of the present disclosure can perform layout calibration for a randomly arranged loudspeaker system, it can therefore be applicable to various loudspeaker layouts, including standard layouts for audio data (for example, for audio data with five channels: left/right/center/left surround/right surround, its standard layout is that five loudspeakers are arranged at five corresponding standard spatial positions, respectively) or non-standard layouts; and for the calibrated layout, there is no need for the user to manually perform audio data assignment; instead, corresponding playback content can be automatically assigned to each loudspeaker according to the determined spatial positions of the loudspeakers (for example, assigning audio data of the left channel to a loudspeaker located on the left side of the user), so as to provide the user with surround sound or spatial sound effects, thereby improving the immersive experience for the user.

According to yet another aspect of the present disclosure, a control device is also provided. FIG. 5 illustrates a schematic diagram of a control device 2000 according to an embodiment of the present disclosure. As mentioned above, this control device may be one loudspeaker in the aforementioned loudspeaker system, or may be a separately existing device. The following description uses the control device being a separate device as an example, but it should be understood that a loudspeaker used as the control device can likewise have the components included in the control device described below.

As shown in FIG. 5, the control device 2000 may include one or more processors 2010, and one or more memories 2020. The memories 2020 have computer-readable code stored therein, the computer-readable code, when executed by the one or more processors 2010, causing the data processing method as described above to be performed.

The processor in the embodiments of the present disclosure may be an integrated circuit chip having signal processing capability. The aforementioned processor may be a general-purpose processor, a digital signal processor (DSP), an application-specific integrated circuit (ASIC), a field-programmable gate array (FPGA), or other programmable logic devices, discrete gates or transistor logic devices, or discrete hardware assemblies. It can implement or execute the methods, steps, and logic block diagrams disclosed in the embodiments of the present application. The general-purpose processor may be a microprocessor or the processor may also be any conventional processor, or the like, which may be based on an X₈₆ architecture or an ARM architecture.

In general, various example embodiments of the present disclosure may be implemented in hardware or special purpose circuit, software, firmware, logic, or any combination thereof. Some aspects may be implemented in hardware, while other aspects may be implemented in firmware or software which may be executed by a controller, microprocessor, or other computing devices. When aspects of embodiments of the present disclosure are illustrated or described as a block diagram, a flowchart, or using some other graphical representation, it will be understood that the blocks, apparatuses, systems, techniques, or methods described herein may be implemented as non-limiting examples in hardware, software, firmware, a special purpose circuit or logic, general purpose hardware or controller or other computing device, or some combination thereof.

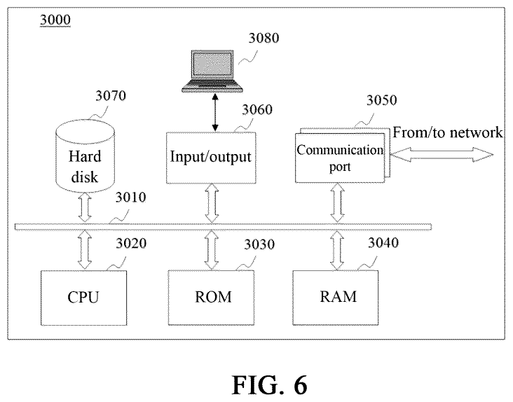

For example, the methods or apparatuses according to embodiments of the present disclosure may also be implemented with the aid of the architecture of the computing device 3000 shown in FIG. 6. As shown in FIG. 6, the computing device 3000 may include a bus 3010, one or more CPUs 3020, a read-only memory (ROM) 3030, a random access memory (RAM) 3040, a communication port 3050 connected to a network, an input/output component 3060, a hard disk 3070, and the like. A storage device in the computing device 3000, for example, a ROM 3030 or a hard disk 3070, may store various data or files used in the processing and/or communication of the data processing method provided in the present disclosure, as well as program instructions executed by the CPU. The computing device 3000 may also include a user interface 3080. Of course, the architecture shown in FIG. 6 is merely exemplary, and when implementing different devices, one or more components in the computing device shown in FIG. 6 may be omitted according to actual needs.

According to yet another aspect of the present disclosure, a computer-readable storage medium is further provided. The computer storage medium has computer-readable instructions stored thereon. The computer-readable instructions, when executed by a processor, may cause the data processing method according to the embodiments of the present disclosure described with reference to the drawings above to be performed. The computer-readable storage medium in the embodiments of the present disclosure may be a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), which is used as an external cache. By way of example and not limitation, many forms of RAM are available, such as static random access memory (SRAM), dynamic random access memory (DRAM), synchronous dynamic random access memory (SDRAM), double data rate synchronous dynamic random access memory (DDRSDRAM), enhanced synchronous dynamic random access memory (ESDRAM), synchronous linked dynamic random access memory (SLDRAM), and direct memory bus random access memory (DR RAM). It should be noted that memory of the methods described herein is intended to include, but is not limited to, these and any other suitable types of memory. It should be noted that memory of the methods described herein is intended to include, but is not limited to, these and any other suitable types of memory.

An embodiment of the present disclosure further provides a computer program product or computer program including computer instructions stored in a computer-readable storage medium. A processor of a computer device reads the computer instructions from the computer-readable storage medium, and the processor executes the computer instructions to cause the computer device to execute the data processing method according to the embodiments of the present disclosure.

Embodiments of the present disclosure provide a data processing method, an apparatus, a device, a computer program product, and a computer-readable storage medium.

The method provided in embodiments of the present disclosure is directed to a loudspeaker system including a plurality of loudspeakers. By collecting locally measured distance information from respective loudspeakers and determining a real-time spatial layout of the loudspeaker system based on the distance information, automatic layout calibration of the loudspeaker system is achieved. Subsequently, according to the layout of the loudspeaker system, and in combination with an actual orientation of a user and spatial position-related data indicative of a position of a sound source in audio content to be played, corresponding data in the audio content is assigned to corresponding loudspeakers, thereby utilizing playback by the respective loudspeakers to collectively achieve spatial audio rendering, providing an immersive sound experience for the user. The method of embodiments of the present disclosure does not require additional layout calibration processing, can achieve real-time layout determination without user awareness, and can automatically adjust audio playback of each loudspeaker according to changes in real-time orientation of the user, thereby achieving user orientation-adaptive spatial audio rendering.

It should be noted that the flowcharts and block diagrams in the drawings illustrate possible architectures, functions, and operations of systems, methods, and computer program products according to various embodiments of the present disclosure. In this regard, each block in the flowcharts or block diagrams may represent a module, a program segment, or a portion of code, which contains at least one executable instruction for implementing a specified logical function. It should also be noted that, in some alternative implementations, the functions noted in the blocks may occur in an order other than that noted in the drawings. For example, two blocks shown in succession may actually be executed substantially in parallel, or they may sometimes be executed in the reverse order, depending on the functionality involved. It should be further noted that each block in the block diagrams and/or flowcharts and a combination of blocks in the block diagrams and/or flowcharts may be implemented by using a dedicated hardware-based system used for executing specified functions or operations, or may be implemented by using a combination of dedicated hardware and a computer instruction.

In general, various example embodiments of the present disclosure may be implemented in hardware or special purpose circuit, software, firmware, logic, or any combination thereof. Some aspects may be implemented in hardware, while other aspects may be implemented in firmware or software which may be executed by a controller, microprocessor, or other computing devices. When aspects of the embodiments of the present disclosure are illustrated or described as a block diagram, a flowchart, or using some other graphical representations, it will be understood that the blocks, apparatuses, systems, techniques, or methods described herein may be implemented as non-limiting examples in hardware, software, firmware, a special purpose circuit or logic, general purpose hardware or controller or other computing devices, or some combinations thereof.

The example embodiments of the present disclosure described in detail above are illustrative only and not restrictive. Those skilled in the art should understand that various modifications and combinations may be made to these embodiments or features thereof without departing from the principles and spirit of the present disclosure, and such modifications should fall within the scope of the present disclosure.

What is claimed is:

1. A data processing method for audio playback of a loudspeaker system comprising a plurality of loudspeakers, the method comprising:
acquiring audio data for playback in the loudspeaker system, where the audio data comprises spatial position-related data indicative of a position of a sound source in the audio data;
receiving loudspeaker distance information from at least a portion of loudspeakers of the plurality of loudspeakers, wherein for each loudspeaker of the at least a portion of loudspeakers, the loudspeaker distance information indicates distances between the loudspeaker and the other loudspeakers in the at least a portion of loudspeakers;
determining a spatial position of each loudspeaker of the at least a portion of loudspeakers based on the received loudspeaker distance information; and
processing the audio data based on a detection of orientation of a user, the spatial position of each loudspeaker of the at least a portion of loudspeakers, and the spatial position-related data in the audio data to determine audio content to be played by each loudspeaker of the at least a portion of loudspeakers for providing spatial audio rendering of the audio data for the user.

2. The method of claim 1, wherein determining the spatial position of each loudspeaker of the at least a portion of loudspeakers based on the received loudspeaker distance information comprises:
constructing a loudspeaker distance matrix based on the received loudspeaker distance information; and
determining spatial coordinates of each loudspeaker of the at least a portion of loudspeakers according to the loudspeaker distance matrix based on a number of loudspeakers in the at least a portion of loudspeakers.

3. The method of claim 2, wherein determining the spatial coordinates of each loudspeaker of the at least a portion of loudspeakers according to the loudspeaker distance matrix based on the number of loudspeakers in the at least a portion of loudspeakers comprises:
in a case where the number of loudspeakers in the at least a portion of loudspeakers satisfies a predetermined condition, determining the spatial coordinates of each loudspeaker of the at least a portion of loudspeakers through multidimensional scaling according to the loudspeaker distance matrix.

4. The method of claim 3, wherein determining the spatial coordinates of each loudspeaker of the at least a portion of loudspeakers through multidimensional scaling according to the loudspeaker distance matrix comprises:
transforming the loudspeaker distance matrix to cause the loudspeaker distance matrix to have a zero mean;
performing eigenvalue decomposition on the loudspeaker distance matrix having the zero mean to determine one or more eigenvalues of the loudspeaker distance matrix having the zero mean and one or more eigenvectors corresponding to the one or more eigenvalues; and
determining the spatial coordinates of each loudspeaker of the at least a portion of loudspeakers based on the one or more eigenvalues and the one or more eigenvectors.

5. The method of claim 2, wherein determining the spatial coordinates of each loudspeaker of the at least a portion of loudspeakers according to the loudspeaker distance matrix based on the number of loudspeakers in the at least a portion of loudspeakers comprises:
in a case where the number of loudspeakers in the at least a portion of loudspeakers does not satisfy a predetermined condition, determining the spatial coordinates of each loudspeaker of the at least a portion of loudspeakers according to the loudspeaker distance matrix by minimizing an objective function, wherein the objective function indicates differences between distances between loudspeakers determined based on estimated spatial coordinates of each loudspeaker of the at least a portion of loudspeakers and corresponding distances in the loudspeaker distance matrix.

6. The method of claim 5, wherein determining the spatial coordinates of each loudspeaker of the at least a portion of loudspeakers according to the loudspeaker distance matrix based on the number of loudspeakers in the at least a portion of loudspeakers further comprises:
transforming the objective function into a bilinear matrix form and determining the spatial coordinates of each loudspeaker of the at least a portion of loudspeakers through eigenvalue decomposition.

7. The method of claim 2, wherein determining the spatial coordinates of each loudspeaker of the at least a portion of loudspeakers according to the loudspeaker distance matrix based on the number of loudspeakers in the at least a portion of loudspeakers further comprises:
optimizing the loudspeaker distance matrix to correct unreliable distances in the loudspeaker distance matrix; and
determining the spatial coordinates of each loudspeaker of the at least a portion of loudspeakers based on the optimized loudspeaker distance matrix.

8. The method of claim 1, wherein the loudspeaker distance information is obtained by the loudspeakers through Bluetooth channel sounding.

9. The method of claim 1, wherein processing the audio data based on the detection of the orientation of the user, the spatial position of each loudspeaker of the at least a portion of loudspeakers, and the spatial position-related data in the audio data comprises:
transforming the spatial position of each loudspeaker of the at least a portion of loudspeakers based on the detection of the orientation of the user to determine a spatial position of each loudspeaker of the at least a portion of loudspeakers relative to the user; and
determining the audio content to be played by each loudspeaker of the at least a portion of loudspeakers from the audio data according to the spatial position-related data in the audio data based on the spatial position of each loudspeaker of the at least a portion of loudspeakers relative to the user.

10. A control device, comprising:
one or more processors; and
one or more memories, wherein the one or more memories have a computer-executable program stored therein, the computer-executable program, the one or more processors configured to:
acquiring audio data for playback in a loudspeaker system, where the audio data comprises spatial position-related data indicative of a position of a sound source in the audio data;
receiving loudspeaker distance information from at least a portion of loudspeakers of a plurality of loudspeakers, wherein for each loudspeaker of the at least a portion of loudspeakers, the loudspeaker distance information indicates distances between the loudspeaker and the other loudspeakers in the at least a portion of loudspeakers;
determining a spatial position of each loudspeaker of the at least a portion of loudspeakers based on the received loudspeaker distance information; and
processing the audio data based on a detection of orientation of a user, the spatial position of each loudspeaker of the at least a portion of loudspeakers, and the spatial position-related data in the audio data to determine audio content to be played by each loudspeaker of the at least a portion of loudspeakers for providing spatial audio rendering of the audio data for the user.

11. The control device of claim 10, wherein determining the spatial position of each loudspeaker of the at least a portion of loudspeakers based on the received loudspeaker distance information comprises:
constructing a loudspeaker distance matrix based on the received loudspeaker distance information; and
determining spatial coordinates of each loudspeaker of the at least a portion of loudspeakers according to the loudspeaker distance matrix based on a number of loudspeakers in the at least a portion of loudspeakers.

12. The control device of claim 11, wherein determining the spatial coordinates of each loudspeaker of the at least a portion of loudspeakers according to the loudspeaker distance matrix based on the number of loudspeakers in the at least a portion of loudspeakers comprises:
in a case where the number of loudspeakers in the at least a portion of loudspeakers satisfies a predetermined condition, determining the spatial coordinates of each loudspeaker of the at least a portion of loudspeakers through multidimensional scaling according to the loudspeaker distance matrix.

13. The control device of claim 12, wherein determining the spatial coordinates of each loudspeaker of the at least a portion of loudspeakers through multidimensional scaling according to the loudspeaker distance matrix comprises:
transforming the loudspeaker distance matrix to cause the loudspeaker distance matrix to have a zero mean;
performing eigenvalue decomposition on the loudspeaker distance matrix having the zero mean to determine one or more eigenvalues of the loudspeaker distance matrix having the zero mean and one or more eigenvectors corresponding to the one or more eigenvalues; and
determining the spatial coordinates of each loudspeaker of the at least a portion of loudspeakers based on the one or more eigenvalues and the one or more eigenvectors.

14. The control device of claim 11, wherein determining the spatial coordinates of each loudspeaker of the at least a portion of loudspeakers according to the loudspeaker distance matrix based on the number of loudspeakers in the at least a portion of loudspeakers comprises:
in a case where the number of loudspeakers in the at least a portion of loudspeakers does not satisfy a predetermined condition, determining the spatial coordinates of each loudspeaker of the at least a portion of loudspeakers according to the loudspeaker distance matrix by minimizing an objective function, wherein the objective function indicates differences between distances between loudspeakers determined based on estimated spatial coordinates of each loudspeaker of the at least a portion of loudspeakers and corresponding distances in the loudspeaker distance matrix.

15. The control device of claim 14, wherein determining the spatial coordinates of each loudspeaker of the at least a portion of loudspeakers according to the loudspeaker distance matrix based on the number of loudspeakers in the at least a portion of loudspeakers further comprises:
transforming the objective function into a bilinear matrix form and determining the spatial coordinates of each loudspeaker of the at least a portion of loudspeakers through eigenvalue decomposition.

16. The control device of claim 11, wherein determining the spatial coordinates of each loudspeaker of the at least a portion of loudspeakers according to the loudspeaker distance matrix based on the number of loudspeakers in the at least a portion of loudspeakers further comprises:
optimizing the loudspeaker distance matrix to correct unreliable distances in the loudspeaker distance matrix; and
determining the spatial coordinates of each loudspeaker of the at least a portion of loudspeakers based on the optimized loudspeaker distance matrix.

17. The control device of claim 10, wherein the loudspeaker distance information is obtained by the loudspeakers through Bluetooth channel sounding.

18. The control device of claim 10, wherein processing the audio data based on the detection of the orientation of the user, the spatial position of each loudspeaker of the at least a portion of loudspeakers, and the spatial position-related data in the audio data comprises:
transforming the spatial position of each loudspeaker of the at least a portion of loudspeakers based on the detection of the orientation of the user to determine a spatial position of each loudspeaker of the at least a portion of loudspeakers relative to the user; and
determining the audio content to be played by each loudspeaker of the at least a portion of loudspeakers from the audio data according to the spatial position-related data in the audio data based on the spatial position of each loudspeaker of the at least a portion of loudspeakers relative to the user.
